(19) United States
(12) Patent Application Publication
(10) Pub. No.: US 2011/0115901 A1
(43) Pub. Date: May 19, 2011

(54) Device for Converting Photographs and Films into Digital Data

(75) Inventor: Mingtong Jian, Shenzhen (CN)

(73) Assignee: VIGORHOOD PHOTOELECTRIC SHENZHEN CO., LTD., Shenzhen, GD (CN)

(21) Appl. No.: 13/003,479

(22) PCT Filed: Dec. 26, 2009
(86) PCT No.: PCT/CN09/76100

§ 371 Date: Jan. 10, 2011

(30) Foreign Application Priority Data
Dec. 31, 2008 (CN) 200820207101.6

(51) Int. Cl. H04N 5/253

(52) U.S. Cl. 348/97; 348/E05.049

(57) ABSTRACT

A device for transferring photo and film into digital file includes an upper shell, a lower shell, a film clip, and a photo clip framework. A PCB bracket is in the upper shell, and a PCB with a camera lens and a sensor is fixed on the PCB bracket; a film clip rail is fixed in the upper shell, a pulley track is under the film clip rail, and a light box is hung under the pulley; the photo framework is in the lower shell; in the lower shell, a light board is on the photo framework. Said camera lens is a bifocal lens, of which one focus is used for picking up the film, and the other one is used for picking up the photo. According to the different imaging modes, the lens is adjusted between the two fixed focus to adapt to the working mode needed.

### FIELD OF THE INVENTION

This invention relates to a device for converting images into digital data, and in particular to a device for converting photographs and film images into digital data.

### BACKGROUND OF THE INVENTION

In the past, traditional cameras captured images by using films, and thus many films or photographs obtained by developing the films are kept in every family. The films or photographs will become aging gradually and are inconvenient for storage such that they will be lost easily. With the advent of digital cameras and computer, many users now prefer to store photographed images electronically.

At the present, devices for converting films or photographs into digital data are mainly scanner and film duplicator. However, the scanner normally has a very slow speed and is expensive if with good scanning quality, while the film duplicator can not convert photographs into digital data.

### SUMMARY OF THE INVENTION

Having the above problems, it is an object of the present invention to provide a device for converting photographs and films into digital data.

To achieve the above object, the present invention provides a device for converting photographs and films into digital data, comprising: an upper shell, a lower shell, a film clamp, a photo clamp, a PCB bracket in the upper shell, and a PCB with a lens and a sensor fixed on the PCB bracket. Film clamp guideways are fixed in the upper shell, and an opening for the entry of the film clamp is provided on the upper shell corresponding to the film clamp guideways. A pulley track is under the film clamp guideway, a pulley is in the pulley track, and the lamp box is hung below the pulley. One end of the pulley track is right below the lens, while the other end is outside the imaging range when shooting photos. The upper shell is provided with a long slot corresponding to the pulley track, and the lamp box button extends through the long slot. The photo clamp is in the lower shell. In the lower shell, a lamp board is provided above the photo clamp.

Preferably, the lens is a bifocal lens with one focal length used for shooting films and the other focal length used for shooting photos. According to different shooting modes, the two fixed focal lengths are respectively adjusted to be adapted to the desired working modes.

Preferably, the device further comprises a photo indicator lamp and a film indicator lamp; the lamp box button has contact points at both ends, the lens has a near focus indication circuit and a far focus indication circuit; the photo indicator lamp, the lamp board, the contact points away from the lens and the far focus indication circuit form a series circuit. The film indicator lamp, the contact points close to the lens of the lamp box button, the lamp box circuit, the near focus indication circuit form a series circuit. The user can determine whether each component is in position according to the signal of the indicator lamp.

Preferably, a tact switch close to the lens and a tact switch away from the lens are respectively provided on both ends of the pulley track. The tact switch close to the lens, the film indicator lamp, the circuit of the lamp box and a near focus switch form a series circuit. The tact switch away from the lens, the photo indicator lamp, the lamp board and a far focus switch form a series circuit. Therefore, when the user would like to change the shooting mode, the triggering of the tact switches will change all the settings, whereby the user does not have to operate multiple buttons as that in the prior art.

Preferably, the opening for the entry of the film clamp on the upper shell has an anti-dust plate.

Preferably, the photo clamp comprises a pair of slideways provided on the lower shell, and an opening for the entry of the photo clamp provided on the lower shell corresponding to the slideways. The lamp board is located on the slideways, and the opening for the entry of the photo clamp has a baffle plate.

Alternatively, the photo clamp is an openable bottom that is adapted to be rotated around an edge of the lower shell.

Preferably, the PCB is connected with a USB port in order to facilitate the connection with a computer for saving the images.

Preferably, a plane where the film clamp guideways are located is parallel to the pulley track, and the film clamp guideways are vertical to the pulley track. The opening for the entry of the film clamp is located at a surface on the upper shell different from that of the lamp box button.

With the above structure, the shooting of the film image and the photo is realized by changing the focal length of the lens. When shooting the film image, the film lamp box is moved to the middle of the backlight bracket, and a long slot for allowing the insertion of the film clamp is provided in the front of the bracket and in front of the backlight. The film image is acquired by the lens and converted into digital data which is then transmitted to the computer for storage. The film image is thus converted into digital data quickly and convenient for modification and permanent storage.

When shooting the photo, the focal length of the lens is changed, and the film backlight is moved from the middle of the bracket to one side to enable the photo light source to turn on. The photo image is then acquired by the lens and converted into digital data which is then transmitted to the computer for storage. The photo image is thus converted into digital data quickly and convenient for modification and permanent storage.

### BRIEF DESCRIPTION OF THE DRAWINGS

FIG. 1 is a schematic sectional view of an embodiment of the present invention;

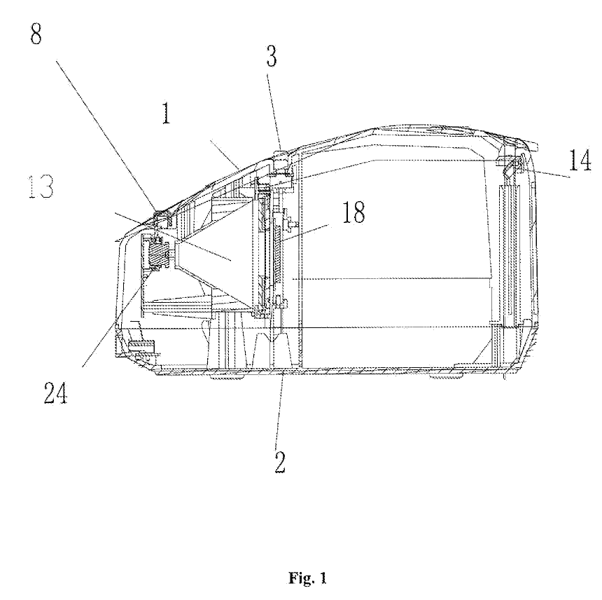

FIG. 2 is a schematic view showing the working state for shooting photos of an embodiment of the present invention;

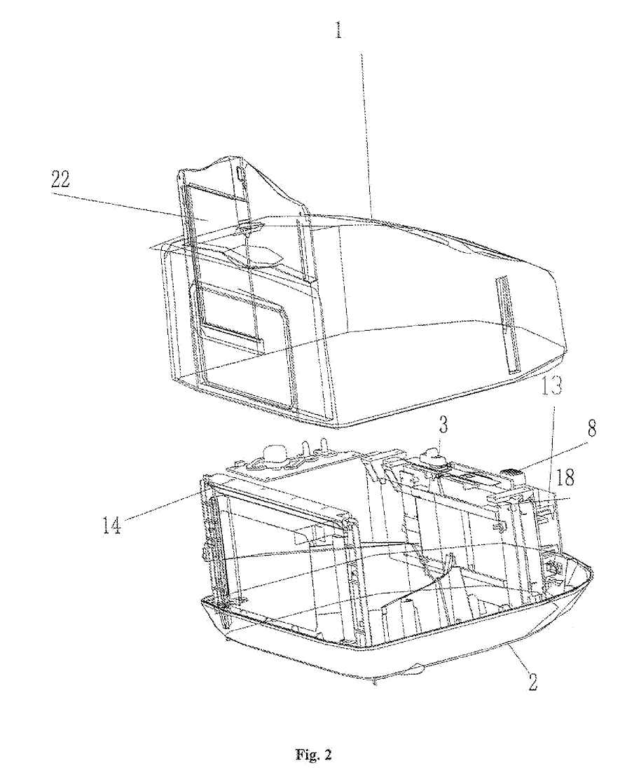

FIG. 3 is a schematic view showing the working state for shooting films of an embodiment of the present invention;

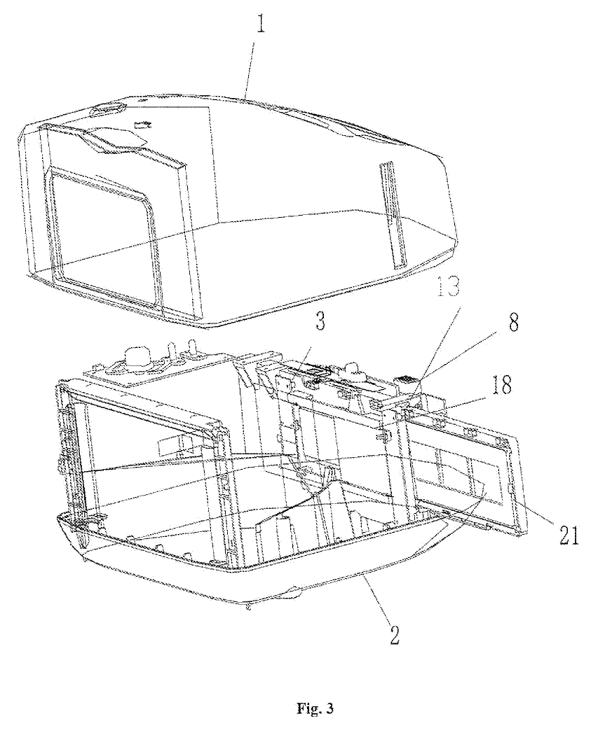

FIG. 4 is a schematic exploded view of an embodiment of the present invention.

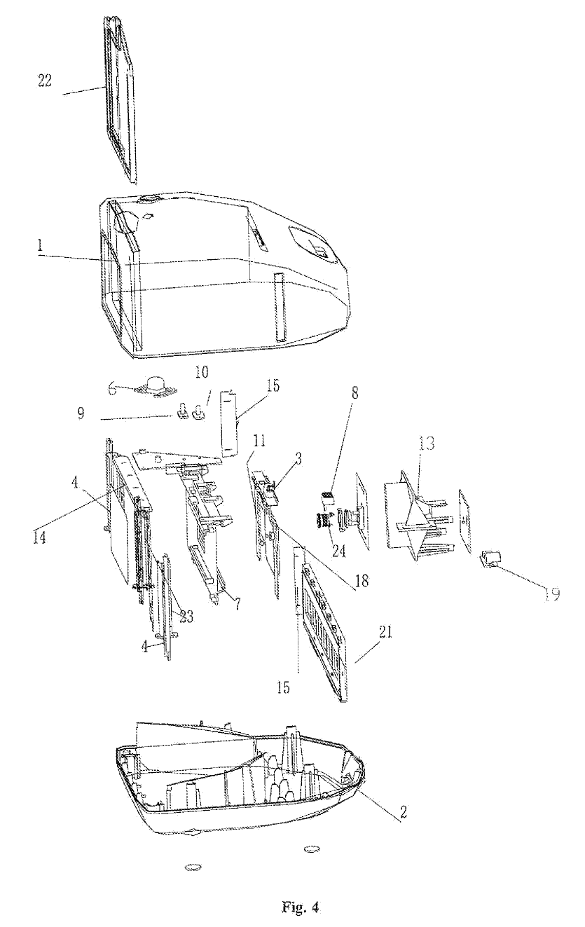

1. upper shell, 2. lower shell, 3. lamp box button, 4. slideway, 7. film clamp guideway, 8. crank handle button, 9. photo indicator lamp, 10. film indicator lamp, 11. pulley, 13. PCB, 14. baffle plate, 15. anti-dust plate, 18. lamp box, 19. USB port, 21. film clamp, 22. photo clamp, 23. lamp board, 24. bifocal lens.

### DETAILED DESCRIPTION OF THE INVENTION

In the following, embodiments will be described in more detail. However, the embodiments described below are only given as examples and should not be limiting to the present invention.

As shown in the figures, the device includes an upper shell 1, a lower shell 2, a film clamp 21, a photo clamp 22, a PCB bracket in the upper shell 1, and a PCB 13 with a bifocal lens 24 and a sensor fixed on the PCB bracket. Film clamp guideways 7 are fixed in the upper shell 1, and an opening for the entry of the film clamp 21 is provided on the upper shell 1 corresponding to the film clamp guideway 7. A pulley track is under the film clamp guideway 7. The plane where the film clamp guideways 7 are located is parallel to the pulley track, and the film clamp guideways 7 are vertical to the pulley track. The opening for the entry of the film clamp 21 is located at a surface on the upper shell 1 different from that of the lamp box button 3. A pulley 11 is in the pulley track, and the lamp box 18 is hung below the pulley 11. One end of the pulley track is right below the bifocal lens 24, while the other end is at the rightmost of the upper shell 1. The upper shell 1 is provided with a long slot corresponding to the pulley track, and the lamp box button 3 extends through the long slot. The crank handle button 8 of the bifocal lens 24 is located on the control board of the upper shell 1.

A tact switch close to the lens and a tact switch away from the lens are respectively provided on both ends of the pulley track. The tact switch close to the lens, the film indicator lamp 10 and the circuit of the lamp box 18 form a series circuit. The tact switch away from the lens, the photo indicator lamp 9 and the lamp board 23 form a series circuit. Therefore, when the user would like to change the shooting mode, the triggering of the tact switches will change all the settings, whereby the user does not have to operate multiple buttons as that in the prior art.

The opening for the entry of the film clamp on the upper shell 1 has an anti-dust plate 15.

A pair of slideways 4 is provided on the lower shell 2, and an opening for the entry of the photo clamp is provided on the lower shell 2 corresponding to the slideways 4. The lamp board 23 is located on the slideways 4, and the opening for the entry of the photo clamp has a baffle plate 14.

The PCB 13 is connected with a USB port 19 in order to facilitate the connection with the computer to store the photos.

With the above structure, the shooting of the film image and the photo is realized by changing the focal length of the lens. When shooting the film image, the film lamp box is moved to the middle of the backlight bracket, and a long slot for allowing the insertion of the film clamp is provided in the front of the bracket and in front of the backlight. The film image is acquired by the lens and converted into digital data which is then transmitted to the computer for storage. The film image is thus converted into digital data quickly and convenient for modification and permanent storage. When shooting the photo, the focal length of the lens is changed, and the film backlight is moved from the middle of the bracket to one side to enable the photo light source to turn on. The photo image is then acquired by the lens and converted into digital data which is then transmitted to the computer for storage. The photo image is thus converted into digital data quickly and convenient for modification and permanent storage.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

What is claimed is:

1. A device for converting photographs and films into digital data, comprising:
an upper shell;
a lower shell;
a film clamp;
a photo clamp;
a PCB bracket in the upper shell; and
a PCB with a lens and a sensor fixed on the PCB bracket;
wherein film clamp guideways are fixed in the upper shell, and an opening for the entry of the film clamp is provided on the upper shell corresponding to the film clamp guideways; a lamp box is provided behind the lens and the film clamp guideways, and the lamp box has a pulley located in a pulley track; one end of the lamp box moving along the pulley track is on the principal axis of the lens, while the other end is outside the imaging range when shooting photos; the upper shell is provided with a long slot corresponding to the pulley track, and a lamp box button extends through the long slot; the photo clamp is in the lower shell; in the lower shell, a lamp board is provided above the photo clamp.

2. The device of claim 1, wherein the lens is a bifocal lens with one focal length used for shooting films and the other focal length used for shooting photos.

3. The device of claim 1, wherein the device further comprises a photo indicator lamp and a film indicator lamp; the lamp box button has contact points at both ends, the lens has a near focus indication circuit and a far focus indication circuit; the photo indicator lamp, the lamp board, the contact points away from the lens of the lamp box button and the far focus indication circuit form a series circuit; the film indicator lamp, the contact points close to the lens of the lamp box button, the lamp box circuit, the near focus indication circuit form a series circuit.

4. The device of claim 3, wherein a tact switch close to the lens and a tact switch away from the lens are respectively provided on both ends of the pulley track; the tact switch close to the lens, the film indicator lamp, a circuit of the lamp box and a near focus switch form a series circuit; the tact switch away from the lens, the photo indicator lamp, the lamp board and a far focus switch form a series circuit.

5. The device of claim 1, wherein the opening for the entry of the film clamp on the upper shell has an anti-dust plate.

6. The device of claim 1, wherein the photo clamp comprises a pair of slideways provided on the lower shell, and an opening for the entry of the photo clamp provided on the lower shell corresponding to the slideways.

7. The device of claim 6, wherein the lamp board is located on the slideways, and the opening for the entry of the photo clamp has a baffle plate.

8. The device of claim 1, wherein the photo clamp is an openable bottom adapted to be rotated around an edge of the lower shell.

9. The device of claim 1, wherein the PCB is connected with a USB port.

10. The device of claim 1, wherein a plane where the film clamp guideways are located is parallel to the pulley track, and the film clamp guideways are vertical to the pulley track, the opening for the entry of the film clamp is located at a surface on the upper shell different from that of the lamp box button.
